(19) United States
(12) Patent Application Publication
(10) Pub. No.: US 2021/0109268 A1
(43) Pub. Date: Apr. 15, 2021

(54) POLARIZING FILM AND METHOD FOR PRODUCING SAME

(71) Applicant: ZEON CORPORATION, Chiyoda-ku, Tokyo (JP)

(72) Inventor: Takamichi INOMATA, Tokyo (JP)

(73) Assignee: ZEON CORPORATION, Chiyoda-ku, Tokyo (JP)

(21) Appl. No.: 16/757,418

(22) PCT Filed: Oct. 18, 2018
(86) PCT No.: PCT/JP2018/038889

§ 371 Date: Apr. 20, 2020

(30) Foreign Application Priority Data
Oct. 31, 2017 (JP) 2017-210490

(51) Int. Cl. G02B 5/30; G02B 1/14; B32B 27/32; B32B 27/30; B32B 27/08; B32B 27/16; B32B 7/12; B32B 27/22; C08L 45/00

(52) U.S. Cl. CPC G02B 5/305; G02B 1/14; B32B 27/325; B32B 27/306; B32B 27/08; B32B 27/16; B32B 2255/26; B32B 27/22; C08L 45/00; B32B 2307/51; B32B 2307/42; B32B 2255/10; B32B 7/12

(57) ABSTRACT

A polarizing film comprises a polarizer layer, a resin layer, an adhesive layer, and a hard coat layer in this order, wherein the resin layer is formed of a resin having a storage elastic modulus, measured as a film having a thickness of 1 mm, of 10 MPa or more and 1000 MPa or less, and the adhesive layer is in direct contact with the hard coat layer.

### FIELD

The present invention relates to a polarizing film and a method for producing the same.

### BACKGROUND

Some polarizers used in a liquid crystal display device or the like, such as polarizers obtained by subjecting a polyvinyl alcohol-based polymer film to a dyeing treatment using a dichroic substance or the like, have properties of being easily deteriorated depending on a use environment such as temperature, humidity, ultraviolet rays, and mechanical force. Thus, a protective layer such as a hard coat layer is sometimes provided to the polarizer in order to protect the polarizer (Patent literatures 1 and 2).

Further, a protective layer is transferred to the surface of a molded article such as a polarizing plate using a transfer foil having the protective layer (Patent literature 3).

### CITATION LIST

### Patent Literature

Patent Literature 1: Japanese Patent Application Laid-Open No. 2014-130298 A
Patent Literature 2: Japanese Patent Application Laid-Open No. 2010-009027 A (corresponding publication: U.S. Patent Application Publication No. 2011/0043733)
Patent Literature 3: International Publication No. 01/092006 (corresponding publication: U.S. Patent Application Publication No. 2004/0028910)

### SUMMARY

### Technical Problem

In recent years, there is an increasing demand for further reduction in thickness of a liquid crystal display device. Thus, there is also a demand for reduction in thickness of a polarizing film including a polarizer. On the other hand, the polarizer needs to be sufficiently prevented from deterioration even if the thickness of the polarizing film is reduced. However, when the polarizing film having the hard coat layer as the protective layer is made thin, it may cause significant curling and may have insufficient ability to protect the polarizer.

Further, in addition to the thin liquid crystal display device, development of flexible liquid crystal display devices and organic light-emitting diode (OLED) display devices is in progress. Thus, the polarizing film is also required to exhibit high restorability after bending.

As such, the polarizing film that is capable of preventing occurrence of significant curling, capable of sufficiently protecting the polarizer, and capable of exhibiting high restorability after bending has been demanded.

### Solution to Problem

As a result of conducting intensive studies to solve the aforementioned problems, the present inventor has found that the aforementioned problems can be solved by a polarizing film including a polarizer layer, a resin layer, an adhesive layer, and a hard coat layer in this order, in which the resin layer is formed of a specific resin and the hard coat layer is in direct contact with the adhesive layer, thereby completing the present invention. That is, the present invention provides the following.

<1> A polarizing film comprising a polarizer layer, a resin layer, an adhesive layer, and a hard coat layer in this order, wherein

the resin layer is formed of a resin having a storage elastic modulus, measured as a film having a thickness of 1 mm, of 10 MPa or more and 1000 MPa or less, and

the adhesive layer is in direct contact with the hard coat layer.

<2> The polarizing film according to <1>, wherein a thickness of the resin layer is 1 μm or more and 13 μm or less.
<3> The polarizing film according to <1> or <2>, wherein a thickness of the polarizer layer is 1 μm or more and 25 μm or less.
<4> The polarizing film according to any one of <1> to <3>, wherein a thickness of the adhesive layer is more than 0 μm and 5 μm or less.
<5> The polarizing film according to any one of <1> to <4>, further comprising a tackiness layer provided on the polarizer layer on a side opposite to the resin layer side, wherein a thickness of the tackiness layer is 2 μm or more and 25 μm or less.
<6> The polarizing film according to any one of <1> to <5>, wherein the resin has a water vapor transmission rate of less than 5 g/(m²·day) as measured as a film having a thickness of 100 μm at 40° C. and 90% RH.
<7> The polarizing film according to any one of <1> to <6>, wherein the resin contains a polymer having an alicyclic structure.
<8> The polarizing film according to <7>, wherein the polymer having an alicyclic structure is one or more types selected from the group consisting of a hydrogenated product of a ring-opening polymer of a monomer having a norbornene structure, an addition copolymer of a monomer having a norbornene structure and an α-olefin, and a hydrogenated product of an addition copolymer of a monomer having a norbornene structure and an α-olefin.
<9> The polarizing film according to <7>, wherein

the polymer having an alicyclic structure is a hydrogenated product [E] of a block copolymer;

the hydrogenated product [E] of the block copolymer is a hydrogenated product of a block copolymer [D];

the block copolymer [D] is a block copolymer composed of a polymer block [A] and a polymer block [B] or a polymer block [C];

the polymer block [A] is a polymer block having as a main component a repeating unit [I] derived from an aromatic vinyl compound;

the polymer block [B] is a polymer block having as main components the repeating unit [I] derived from an aromatic vinyl compound and a repeating unit [II] derived from a chain conjugated diene compound; and

the polymer block [C] is a polymer block having as a main component the repeating unit [II] derived from a chain conjugated diene compound.

<10> The polarizing film according to any one of <1> to <9>, wherein the resin further contains a plasticizer and/or a softener.
<11> The polarizing film according to <10>, wherein the plasticizer and/or softener is one or more types selected from the group consisting of a compound having an ester structure and an aliphatic hydrocarbon polymer.
<12> The polarizing film according to any one of <1> to <11>, wherein, when a 10 cm square cut piece cut out from the polarizing film is placed on a horizontal plane after humidity control is performed in an environment of 23° C. and 55% RH for 24 hours, a maximum value of heights at four vertices of the cut piece from the horizontal plane is 30 mm or less.
<13> The polarizing film according to any one of <1> to <12>, wherein the polarizer layer includes a polyvinyl alcohol resin.
<14> A method for producing a polarizing film including a polarizer layer, a resin layer, an adhesive layer, and a hard coat layer in this order, the resin layer being formed of a resin having a storage elastic modulus, measured as a film having a thickness of 1 mm, of 10 MPa or more and 1000 MPa or less, the adhesive layer being in direct contact with the hard coat layer, the method comprising the steps of:

forming the hard coat layer on a surface of a temporary support;

preparing a laminated body including the polarizer layer and the resin layer;

bonding a surface of the resin layer of the laminated body and the hard coat layer formed on the surface of the temporary support through an adhesive layer; and

peeling off the temporary support from the hard coat layer.

### Advantageous Effects of Invention

According to the present invention, there is provided a polarizing film that is capable of preventing the occurrence of significant curling, capable of sufficiently protecting the polarizer, and capable of exhibiting high restorability after bending.

### BRIEF DESCRIPTION OF DRAWINGS

FIG. 1 is a cross-sectional view schematically illustrating a polarizing film according to a first embodiment of the present invention.

FIG. 2 is a cross-sectional view schematically illustrating an image display device including a polarizing film according to a second embodiment of the present invention.

FIG. 3 is a cross-sectional view schematically illustrating an image display device including a polarizing film according to a third embodiment of the present invention.

FIG. 4 is an explanatory diagram illustrating the method for producing the polarizing film according to an embodiment of the present invention.

### DESCRIPTION OF EMBODIMENTS

Hereinafter, the present invention will be described in detail with reference to embodiments and examples. However, the present invention is not limited to the following embodiments and examples, and may be freely modified for implementation without departing from the scope of claims of the present invention and the scope of their equivalents. The same reference numerals are given to the same elements, and descriptions thereof may be omitted.

In the following description, a “long-length” film refers to a film with the length that is 5 times or more the width of the film, and preferably a film with the length that is 10 times or more the width thereof, and specifically refers to a film having a length that allows a film to be wound up into a rolled shape for storage or transportation. The upper limit of the ratio of the length thereof relative to the width of the film may be, but not particularly limited to, for example, 100,000 times or less the width.

In the following description, an adhesive includes not only an adhesive in a narrow sense but also a tackiness agent of which a shear storage elastic modulus at 23° C. is less than 1 MPa, unless otherwise specified. Herein, the adhesive in the narrow sense refers to an adhesive of which the shear storage elastic modulus at 23° C. after irradiation with energy rays or a heating treatment is 1 MPa to 500 MPa.

In the following description, the terms “plate”, “layer”, and “film” may refer to a rigid member or a flexible member such as, for example, a film formed of a resin, unless otherwise specified.

In the following description, an in-plane retardation Re of a film is a value represented by Re=(nx−ny)×d, unless otherwise specified. Herein, nx represents a refractive index in a direction in which the maximum refractive index is given among directions perpendicular to the thickness direction of the film (in-plane directions), ny represents a refractive index in a direction, among the above-mentioned in-plane directions of the film, orthogonal to the direction giving nx, and d represents the thickness of the film. The measurement wavelength is 590 nm unless otherwise specified.

### 1. Polarizing Film

The polarizing film according to an embodiment of the present invention includes a polarizer layer, a resin layer, an adhesive layer, and a hard coat layer in this order, and the adhesive layer is in direct contact with the hard coat layer.

### 1.1. Resin Layer

### [Resin Forming the Resin Layer]

The resin forming the resin layer usually contains a polymer. Examples of the polymer contained in the resin of the resin layer may include a polyester, an acrylic polymer, and a polymer having an alicyclic structure.

It is preferable that the resin forming the resin layer contains a polymer having an alicyclic structure.

The polymer having an alicyclic structure is a polymer in which a structural unit of the polymer has an alicyclic structure. A polymer having an alicyclic structure usually has a low water vapor transmission rate. Therefore, by forming the resin layer with the resin containing a polymer having an alicyclic structure, it is possible to suppress water vapor from reaching the polarizer layer so as to improve the moisture resistance of the polarizing film.

The resin forming the resin layer may contain one type of the polymer having an alicyclic structure alone or a combination of two or more types thereof.

The polymer having an alicyclic structure may have an alicyclic structure in a main chain, may have an alicyclic structure in a side chain, or may have an alicyclic structure in both the main chain and the side chain. Among these, a polymer having an alicyclic structure in at least a main chain is preferable from the viewpoint of mechanical strength and heat resistance.

Examples of the alicyclic structure may include a saturated alicyclic hydrocarbon (cycloalkane) structure, and an unsaturated alicyclic hydrocarbon (cycloalkene, cycloalkyne) structure. Among these, a cycloalkane structure and a cycloalkene structure are preferable from the viewpoint of mechanical strength and heat resistance. A cycloalkane structure is particularly preferable among these.

The number of carbon atoms constituting the alicyclic structure is preferably 4 or more, and more preferably 5 or more, and is preferably 30 or less, more preferably 20 or less, and particularly preferably 15 or less, per alicyclic structure. By setting the number of carbon atoms constituting the alicyclic structure to be within this range, mechanical strength, heat resistance, and moldability of the resin containing the polymer having an alicyclic structure are balanced at a high level.

The ratio of a structural unit having an alicyclic structure in the polymer having an alicyclic structure may be appropriately selected according to the intended use. The ratio of the structural unit having an alicyclic structure in the polymer having an alicyclic structure is preferably 55% by weight or more, more preferably 70% by weight or more, and particularly preferably 90% by weight or more, and may be 100% by weight or less. When the ratio of the structural unit having an alicyclic structure in the polymer having an alicyclic structure falls within this range, the resin containing the polymer having an alicyclic structure has good transparency and heat resistance.

Examples of the polymer having an alicyclic structure may include a norbornene-based polymer, a monocyclic olefin-based polymer, a cyclic conjugated diene-based polymer, a vinyl alicyclic hydrocarbon polymer, and hydrogenated products thereof, and a hydrogenated product of a vinyl aromatic hydrocarbon polymer. Among these, one or more types selected from the group consisting of a norbornene-based polymer and a hydrogenated product of a vinyl aromatic hydrocarbon polymer are more preferable because of their good transparency and moldability.

Examples of the norbornene-based polymer may include a ring-opening polymer of a monomer having a norbornene structure and a hydrogenated product thereof; and an addition polymer of a monomer having a norbornene structure and a hydrogenated product thereof. Examples of the ring-opening polymer of a monomer having a norbornene structure may include a ring-opening homopolymer of one type of monomer having a norbornene structure, a ring-opening copolymer of two or more types of monomers having a norbornene structure, and a ring-opening copolymer of a monomer having a norbornene structure and an optional monomer copolymerizable therewith. Further, examples of the addition polymer of a monomer having a norbornene structure may include an addition homopolymer of one type of monomer having a norbornene structure, an addition copolymer of two or more types of monomers having a norbornene structure, and an addition copolymer of a monomer having a norbornene structure and an optional monomer copolymerizable therewith. Among these, a hydrogenated product of a ring-opening polymer of a monomer having a norbornene structure, an addition copolymer of a monomer having a norbornene structure and an α-olefin, and a hydrogenated product of the addition copolymer of a monomer having a norbornene structure and an α-olefin are preferable. A hydrogenated product of a ring-opening copolymer of two or more types of monomers having a norbornene structure, an addition copolymer of a monomer having a norbornene structure and an α-olefin, and a hydrogenated product of the addition copolymer of a monomer having a norbornene structure and an α-olefin are more preferable.

Examples of the monomer having a norbornene structure may include bicyclo[2.2.1]hept-2-ene (common name: norbornene), tricyclo[4.3.0.1^{2,5}]deca-3,7-diene (common name: dicyclopentadiene), 7,8-benzotricyclo[4.3.0.1^{2,5}]dec-3-ene (common name: methanotetrahydrofluorene), tetracyclo[4.4.0.1^{2,5} 0.1^{7,10}]dodeca-3-ene (common name: tetracyclododecene), and derivatives of these compounds (for example, those with a substituent on the ring). Examples of the substituent may include an alkyl group, an alkylene group, and a polar group. A plurality of these substituents, which may be the same as or different from each other, may be bonded to a ring. As the monomer having a norbornene structure, one type thereof may be solely used, and two or more types thereof may also be used in combination at any ratio.

Examples of the polar group may include a heteroatom, and an atomic group having a heteroatom. Examples of the heteroatom may include an oxygen atom, a nitrogen atom, a sulfur atom, a silicon atom, and a halogen atom. Specific examples of the polar group may include a carboxyl group, a carbonyloxycarbonyl group, an epoxy group, a hydroxyl group, an oxy group, an ester group, a silanol group, a silyl group, an amino group, a nitrile group, and a sulfonic acid group.

Examples of the monomer that is ring-opening copolymerizable with the monomer having a norbornene structure may include monocyclic olefins such as cyclohexene, cycloheptene, and cyclooctene, and derivatives thereof; and cyclic conjugated dienes such as cyclohexadiene and cycloheptadiene, and derivatives thereof. As the monomer that is ring-opening copolymerizable with the monomer having a norbornene structure, one type thereof may be solely used, and two or more types thereof may also be used in combination at any ratio.

The ring-opening polymer of the monomer having a norbornene structure may be produced, for example, by polymerizing or copolymerizing the monomer in the presence of a ring-opening polymerization catalyst.

Examples of the α-olefin in the addition copolymer of the monomer having a norbornene structure and the α-olefin may include α-olefins of 2 to 20 carbon atoms such as ethylene, propylene, and 1-butene, and derivatives thereof. Among these, ethylene is preferable. As the α-olefin, one type thereof may be solely used, and two or more types thereof may also be used in combination at any ratio.

The addition polymer of the monomer having a norbornene structure may be produced, for example, by polymerizing or copolymerizing the monomer in the presence of an addition polymerization catalyst.

The above-mentioned hydrogenated products of the ring-opening polymer and the addition polymer may be produced, for example, by hydrogenating an unsaturated carbon-carbon bond, preferably 90% or more thereof, in a solution of the ring-opening polymer and the addition polymer in the presence of a hydrogenation catalyst containing a transition metal such as nickel, palladium, or the like.

The hydrogenated product of a vinyl aromatic hydrocarbon polymer means a hydrogenated product of a polymer containing a repeating unit [I] derived from an aromatic vinyl compound. The repeating unit derived from an aromatic vinyl compound means a repeating unit having a structure obtained by polymerizing an aromatic vinyl compound. However, the hydrogenated product and its constituent unit are not limited by the producing method.

Examples of the aromatic vinyl compound corresponding to the repeating unit [I] may include styrene; styrenes having an alkyl group of 1 to 6 carbon atoms as a substituent such as α-methylstyrene, 2-methylstyrene, 3-methylstyrene, 4-methylstyrene, 2,4-dimethylstyrene, 2,4-diisopropylstyrene, 4-t-butylstyrene, and 5-t-butyl-2-methylstyrene; styrenes having a halogen atom as a substituent such as 4-chlorostyrene, dichlorostyrene, and 4-monofluorostyrene; styrenes having an alkoxy group of 1 to 6 carbon atoms as a substituent such as 4-methoxystyrene; styrenes having an aryl group as a substituent such as 4-phenylstyrene; and vinylnaphthalenes such as 1-vinylnaphthalene and 2-vinylnaphthalene. As these compounds, one type thereof may be solely used, and two or more types thereof may also be used in combination at any ratio. Among these, an aromatic vinyl compound which does not include a polar group such as styrene and styrenes having an alkyl group of 1 to 6 carbon atoms as a substituent is preferable because therewith hygroscopicity can be kept at a low level, and styrene is particularly preferable from the viewpoint of industrial availability.

The hydrogenated product of the polymer containing the repeating unit [I] derived from an aromatic vinyl compound is preferably a hydrogenated product [E] of a specific block copolymer. The hydrogenated product [E] of a block copolymer is a hydrogenated product of a block copolymer [D]. The block copolymer [D] is a polymer block composed of a polymer block [A], together with either one of a polymer block [B] and a polymer block [C]. The polymer block [A] is a polymer block having, as a main component, a repeating unit [I] derived from an aromatic vinyl compound. The polymer block [B] is a polymer block having, as main components, the repeating unit [I] derived from an aromatic vinyl compound and a repeating unit [II] derived from a chain conjugated diene compound. The polymer block [C] is a polymer block having, as a main component, the repeating unit [II] derived from a chain conjugated diene compound. Herein, the “main component” refers to a component which is contained in an amount of 50% by weight or more in the polymer block. The repeating unit derived from a chain conjugated diene compound means a repeating unit having a structure obtained by polymerizing a chain conjugated diene compound.

Examples of the chain conjugated diene compound corresponding to the repeating unit [II] may include 1,3-butadiene, isoprene, 2,3-dimethyl-1,3-butadiene, and 1,3-pentadiene. As these compounds, one type thereof may be solely used, and two or more types thereof may also be used in combination at any ratio. The chain conjugated diene compound may be linear or branched.

The hydrogenated product of the vinyl aromatic hydrocarbon polymer is a substance obtained by hydrogenating unsaturated bonds of the vinyl aromatic hydrocarbon polymer. Herein, the unsaturated bonds of the vinyl aromatic hydrocarbon polymer to be hydrogenated include both carbon-carbon unsaturated bonds of the main chain and the side chain of the polymer, and carbon-carbon unsaturated bonds of the aromatic ring.

The hydrogenated product may be produced, for example, by hydrogenating the unsaturated bonds of the polymer, preferably 90% or more thereof, in a solution of a vinyl aromatic hydrocarbon polymer in the presence of a hydrogenation catalyst containing a transition metal such as nickel, palladium, or the like.

The weight-average molecular weight Mw of the polymer contained in the resin forming the resin layer is preferably 10,000 or more, more preferably 15,000 or more, and particularly preferably 20,000 or more, and is preferably 100,000 or less, more preferably 80,000 or less, and particularly preferably 50,000 or less. When the weight-average molecular weight falls within such a range, mechanical strength and moldability of the resin layer are balanced at a high level.

The molecular weight distribution (Mw/Mn) of the polymer contained in the resin forming the resin layer is preferably 1.2 or more, more preferably 1.5 or more, and particularly preferably 1.8 or more, and is preferably 3.5 or less, more preferably 3.0 or less, and particularly preferably 2.7 or less. Herein, Mn represents the number-average molecular weight. By setting the molecular weight distribution to be equal to or more than the lower limit value of the aforementioned range, productivity of the polymer can be increased and production cost can be suppressed. When the molecular weight distribution is set to be equal to or less than the upper limit value, the amount of the low-molecular component is kept at a low level. As a result, relaxation of the resin layer upon exposure to high temperature environment can be suppressed and stability of the resin layer can be improved.

The aforementioned weight-average molecular weight (Mw) and number-average molecular weight (Mn) may be measured using gel permeation chromatography (GPC). Examples of the solvents used in GPC may include cyclohexane, toluene, and tetrahydrofuran. When GPC is used, the weight-average molecular weight is measured, for example, as a polyisoprene-equivalent or polystyrene-equivalent relative molecular weight.

It is preferable that the resin forming the resin layer further contains a plasticizer and/or a softener (plasticizer or softener, or both) in addition to the polymer. When the resin further contains a plasticizer and/or a softener, the moldability (e.g., extensibility) of the resin forming the resin layer can be improved.

Examples of the plasticizer and/or softener may include a compound having an ester structure and an aliphatic hydrocarbon polymer. The resin forming the resin layer preferably contains, as a plasticizer and/or a softener, one or more types selected from the group consisting of a compound having an ester structure and an aliphatic hydrocarbon polymer, and more preferably contains an aliphatic hydrocarbon polymer.

Examples of the compounds having an ester structure may include a phosphoric acid ester compound such as triphenyl phosphate, tricresyl phosphate, and phenyldiphenyl phosphate; an aliphatic carboxylic acid ester such as an oxalic acid ester, a malonic acid ester, a succinic acid ester, a glutaric acid ester, an adipic acid ester, a pimelic acid ester, a suberic acid ester, an azelaic acid ester, a sebacic acid ester, and a stearic acid ester; and an aromatic carboxylic acid ester compound such as a benzoic acid ester, a phthalic acid ester, an isophthalic acid ester, a terephthalic acid ester, a trimellitic acid ester, and a pyromellitic acid ester.

Examples of the aliphatic hydrocarbon polymer may include polyisobutene, hydrogenated polyisobutene, hydrogenated polyisoprene, a hydrogenated 1,3-pentadiene-based petroleum resin, a hydrogenated cyclopentadiene-based petroleum resin, and a hydrogenated styrene/indene-based petroleum resin.

The sum of the plasticizer and the softener relative to 100 parts by weight of the polymer contained in the resin forming the resin layer is preferably 5 parts by weight or more, more preferably 10 parts by weight or more, and still more preferably 20 parts by weight or more, and is preferably 100 parts by weight or less, more preferably 70 parts by weight or less, and still more preferably 50 parts by weight or less. By setting the ratio of the sum of the plasticizer and the softener in the resin to be within the aforementioned range, moldability of the resin can be further improved.

The resin forming the resin layer may contain various additives other than the polymer and the plasticizer and/or the softener. Examples of the additives may include an antioxidant, an ultraviolet absorber, and a light stabilizer.

[Properties of Resin]

The resin forming the resin layer has a storage elastic modulus, measured as a film having a thickness of 1 mm, of usually 10 MPa or more, preferably 50 MPa or more, more preferably 150 MPa or more, and still more preferably 200 MPa or more, and of usually 1000 MPa or less, preferably 900 MPa or less, and more preferably 850 MPa or less.

Since the resin layer is formed of a resin having a storage elastic modulus falling within the aforementioned range, the polarizing film that is capable of preventing the occurrence of significant curling, capable of sufficiently protecting the polarizer, and capable of exhibiting high restorability after bending can be obtained.

The storage elastic modulus may be measured by using a commercially available dynamic viscoelasticity measuring device, and specifically, may be measured as described in the description of the evaluation in Examples.

The resin forming the resin layer preferably has a water vapor transmission rate of less than 5 g/(m²·day), more preferably 4 g/(m²·day) or less as measured as a film having a thickness of 100 μm at 40° C. and 90% RH, and the lower limit value thereof is ideally 0 g/(m²·day) and may be 0.1 g/(m²·day). When the water vapor transmission rate is equal to or less than the upper limit value, low moisture permeability of the resin layer can be made sufficiently excellent, so that the water vapor can be prevented from reaching the polarizer layer and the reliability of the polarizing film can be made excellent. A water vapor transmission rate may be measured using a commercially available water vapor transmission rate measuring apparatus, and specifically, may be measured as described in the description of evaluation in Examples.

The thickness of the resin layer is preferably 1 μm or more, more preferably 2 μm or more, and still more preferably 3 μm or more, and is preferably 13 μm or less, more preferably 10 μm or less, and still more preferably 7 μm or less. By setting the thickness of the resin layer to be equal to or more than the aforementioned lower limit value, reliability of the polarizing film in a high temperature and high humidity environment can be further improved, so that the polarizer layer included in the polarizing film can be protected more favorably. By setting the thickness of the resin layer to be equal to or less than the aforementioned upper limit value, thickness of the polarizing film can be reduced.

The resin layer may be produced, for example, by extruding the resin forming the resin layer from an extruder equipped with a T-die to form the resin layer on a film, and stretching the film as necessary. The resin layer may be stretched or unstretched. However, by producing the resin layer by a process including stretching, a thin polarizing film can be easily produced.

It is preferable that the resin layer is optically substantially isotropic. Herein, “optically substantially isotropic” means that the in-plane retardation Re is preferably 0 nm or more and 5 nm or less, more preferably 0 nm or more and 2 nm or less.

The surface of the resin layer may be subjected to a corona treatment or the like. This treatment can cause the resin layer to exhibit the performance of, for example, improving the adhesiveness with the adhesive layer.

### 1.2. Polarizer Layer

As the polarizer layer, a film capable of allowing to pass therethrough one of two linearly polarized lights crossing at a right angle, and capable of absorbing or reflecting the other may be used. Specific examples of the polarizer layer may include a polarizer layer obtained by subjecting a film of a polyvinyl alcohol resin, containing a vinyl alcohol-based polymer such as polyvinyl alcohol and partially formalized polyvinyl alcohol, to appropriate treatments such as a dyeing treatment with a dichroic substance such as iodine or a dichroic dye, a stretching treatment, and a crosslinking treatment in an appropriate order and procedure. It is preferable that the polarizer layer includes a polyvinyl alcohol resin.

[Thickness of Polarizer Layer]

The thickness of the polarizer layer is preferably 1 μm or more, more preferably 2 μm or more, and still more preferably 4 μm or more, and is preferably 25 μm or less, and more preferably 23 μm or less.

### 1.3. Hard Coat Layer

The hard coat layer usually has a hardness higher than that of the resin layer, and has a function of suppressing occurrence of scratches on the surface of the resin layer. It is preferable that the hard coat layer exhibits a hardness of “HB” or higher in the pencil hardness test defined in JIS K5600-5-4.

It is preferable that the hard coat layer has a scratch resistance to such an extent that no scratch is visually observed when the steel wool #0000 is pressed against the hard coat layer under a load of 0.025 MPa and reciprocated over the surface of the hard coat layer 10 times and then the surface is observed.

The hard coat layer may have an anti-glare function and/or a reflection reducing function.

Examples of the composition for forming the hard coat layer may include a composition containing an active energy ray curable resin, which has an ability to be cured by active energy rays, and fine particles. Examples of the active energy rays may include ultraviolet rays and electron beams.

As the active energy ray curable resin, a resin exhibiting a hardness of “HB” or higher in the pencil hardness test defined in JIS K5600-5-4 after curing is preferable.

Examples of the active energy ray curable resin may include an organic silicone-based active energy ray curable resin, a melamine-based active energy ray curable resin, an epoxy-based active energy ray curable resin, an acrylic-based active energy ray curable resin, a urethane acrylate-based active energy ray curable resin, and a polyfunctional acrylate-based active energy ray curable resin. Among these, a urethane acrylate-based ultraviolet curable resin and/or a polyfunctional acrylate-based ultraviolet curable resin are preferable from the viewpoint of good adhesion, and excellent toughness and productivity.

The fine particles can adjust various properties such as conductivity and refractive index of the hard coat layer. The fine particles preferably have a refractive index of 1.4 or more.

The fine particles may be organic fine particles composed of an organic substance or inorganic fine particles composed of an inorganic substance. The fine particles are preferably inorganic fine particles, more preferably inorganic oxide fine particles. Examples of the inorganic oxides for constituting fine particles may include silica, titania (titanium oxide), zirconia (zirconium oxide), zinc oxide, tin oxide, cerium oxide, antimony pentoxide, titanium dioxide, tin-doped indium oxide (ITO), antimony-doped tin oxide (ATO), phosphorous-doped tin oxide (PTO), zinc-doped indium oxide (IZO), aluminum-doped zinc oxide (AZO), and fluorine-doped tin oxide (FTO).

As the fine particles, silica fine particles are preferable because they are excellent in a balance between adhesiveness to a resin as a binder forming the hard coat layer and transparency, and can easily adjust the refractive index of the hard coat layer.

The composition for forming the hard coat layer may contain one type of fine particles solely or a combination of two or more types.

The number-average particle diameter of the fine particles is preferably 1 nm or more and 1000 nm or less, more preferably 1 nm or more and 500 nm or less, and still more preferably 1 nm or more and 250 nm or less. The fine particles having small number-average particle diameter can lower the haze of the hard coat layer, and can elevate the adhesiveness between the fine particles and the resin as the binder forming the hard coat layer.

The haze (%) may be measured in accordance with JIS K-7136 using, for example, a commercially available haze meter (for example, “NDH 2000” manufactured by Nippon Denshoku Industries Co., Ltd.) or the like.

In the composition for forming the hard coat layer, the containing amount of the fine particles is preferably 10 to 80 parts by weight, more preferably 10 to 50 parts by weight, and still more preferably 20 to 40 parts by weight, relative to 100 parts by weight of the active energy ray curable resin. When the containing amount of the fine particles falls within the aforementioned range, the optical characteristics such as the haze value and the total light transmittance become excellent.

The total light transmittance (%) may be measured in accordance with JIS K-7361 using, for example, a commercially available haze meter (“NDH 2000” manufactured by Nippon Denshoku Industries Co., Ltd.) or the like.

The composition for forming the hard coat layer may contain a solvent for dissolving or dispersing the active energy ray curable resin. Examples of the solvent may include alcohols such as methanol, ethanol, isopropanol, n-butanol, and isobutanol; glycols such as ethylene glycol, ethylene glycol monobutyl ether, ethylene glycol monoethyl ether acetate, diethylene glycol, diethylene glycol monobutyl ether, and diacetone glycol; aromatic hydrocarbons such as toluene and xylene; aliphatic hydrocarbons such as n-hexane and n-heptane; esters such as ethyl acetate and butyl acetate; ketones such as methyl ethyl ketone and methyl isobutyl ketone; oximes such as methyl ethyl ketoxime; and combinations of two or more of these.

When the active energy ray curable resin is cured by ultraviolet rays, the composition for forming the hard coat layer may further contain a photopolymerization initiator. The photopolymerization initiator may be photopolymerization initiators that are known in prior art. Specific examples thereof may include benzophenone, “Darocur 1173”, “Irgacure 651”, “Irgacure 184”, “Irgacure 907”, and “Irgacure 754” manufactured by Ciba Specialty Chemicals, Inc., and the like.

The composition for forming the hard coat layer may contain various additives (for example, a polymerization inhibitor, an antioxidant, an ultraviolet absorber, an antistatic agent, a light stabilizer, a solvent, an antifoaming agent, and a leveling agent) other than the aforementioned fine particles and active energy ray curable resin.

The thickness of the hard coat layer is preferably 0.5 μm or more and 20 μm or less, more preferably 0.5 μm or more and 10 μm or less, and still more preferably 0.5 μm or more and 8 μm or less.

### 1.4. Adhesive Layer

As the adhesive constituting the adhesive layer to be in direct contact with the hard coat layer, an adhesive that bonds the hard coat layer to the resin layer well may be used. Examples of the adhesives may include, but not particularly limited to, an acryl-based adhesive; an epoxy-based adhesive; a urethane-based adhesive; a polyester-based adhesive; a polyvinyl alcohol-based adhesive; a polyolefin-based adhesive; a modified polyolefin-based adhesive; a polyvinyl alkyl ether-based adhesive; a rubber-based adhesive; a vinyl chloride-vinyl acetate-based adhesive; an ethylene-based adhesive such as an SEBS (styrene-ethylene-butylene-styrene copolymer)-based adhesive and an ethylene-styrene copolymer; and an acrylic acid ester-based adhesive such as an ethylene-methyl(meth)acrylate copolymer and an ethylene-ethyl(meth)acrylate copolymer.

The thickness of the adhesive layer is usually larger than 0 μm, preferably 0.1 μm or more, and more preferably 1 μm or more, and is preferably 5 μm or less, and more preferably 3 μm or less. When the thickness of the adhesive layer falls within the aforementioned range, the adhesive layer can bond the hard coat layer to the resin layer more strongly, and the bending restorability of the polarizing film can be improved, and the thickness of the polarizing film can be reduced.

### 1.5. Other Optional Layers

The polarizing film may include an optional layer other than the polarizer layer, the resin layer, the adhesive layer that is in direct contact with the hard coat layer, and the hard coat layer. Examples of the optional layers may include a temporary support used for forming the hard coat layer, a tackiness layer provided on the polarizer layer on the side opposite to the resin layer side, and an optically anisotropic layer.

The thickness of the tackiness layer that may be provided on the polarizer layer on the side opposite to the resin layer side is preferably 2 μm or more, and more preferably 5 μm or more, and is preferably 25 μm or less, and more preferably 20 μm or less.

The optically anisotropic layer may be provided at any position. For example, the optically anisotropic layer may be provided between the resin layer and the adhesive layer, or may be provided on the polarizer layer on the side opposite to the resin layer side. When the optically anisotropic layer is provided on the polarizer layer on the side opposite to the resin layer side and the polarizing film includes a tackiness layer provided on the polarizer layer on the side opposite to the resin layer side, the optically anisotropic layer is preferably provided between the tackiness layer and the polarizer layer. The optically anisotropic layer means a layer having optical anisotropy, and includes, for example, a layer in which nx, ny, and nz are not the same value. Herein, nz represents the refractive index in the thickness direction of the layer. Specific examples of the optically anisotropic layer may include a 1/4λ film, a uniaxial viewing angle compensation film, a biaxial viewing angle compensation film, and a tilted alignment film, and any of them may be used as one sheet or a combination of a plurality of sheets depending on the use application.

The temporary support will be described later.

### 1.6. Properties of Polarizing Film

As to the polarizing film, when a 10 cm square cut piece cut out from the polarizing film is placed on a horizontal plane after humidity control is effected in an environment of 23° C. and 55% RH for 24 hours, it is preferable that the maximum value of heights at four vertices of the cut piece from the horizontal plane is 30 mm or less. By having such a property, the polarizing film can be easily mounted on an optical element such as an image display element.

The polarizing film preferably has an ultraviolet absorbing property. Specifically, the light transmittance of the polarizing film at 380 nm is preferably 10% or less. In order to impart the ultraviolet absorbing property to the polarizing film, it is preferable that the ultraviolet absorbing property is imparted to at least one layer of the layers (for example, the hard coat layer, the adhesive layer, the resin layer, and the tackiness layer) included in the polarizing film, and in particular, it is more preferable that at least one layer of the layers included in the polarizing film contains an ultraviolet absorber.

### 1.7. Layer Configuration of Polarizing Film

Layer configurations of the polarizing films according to embodiments will be described below with reference to the drawings.

### First Embodiment

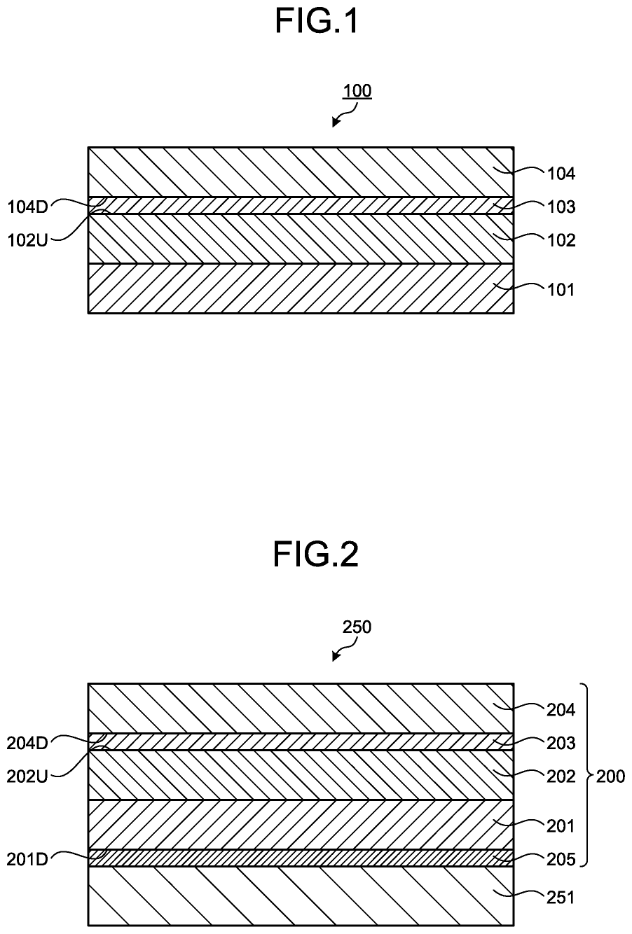

FIG. 1 is a cross-sectional view schematically illustrating a polarizing film according to a first embodiment of the present invention. A polarizing film 100 includes a polarizer layer 101, a resin layer 102, an adhesive layer 103, and a hard coat layer 104 in this order, and the hard coat layer 104 is in direct contact with the adhesive layer 103. The resin layer 102 and the hard coat layer 104 are laminated through the adhesive layer 103. The polarizer layer 101 is in direct contact with the resin layer 102, and a surface 102U of the resin layer 102 and a surface 104D of the hard coat layer are in direct contact with the adhesive layer 103.

In the present embodiment, the resin layer 102 is in direct contact with the adhesive layer 103. However, the polarizing film may include an optically anisotropic layer between the resin layer and the adhesive layer. Further, in the present embodiment, the polarizer layer 101 is positioned on the outermost side of the polarizing film 100. However, the optically anisotropic layer may be disposed on the polarizer layer on the side opposite to the resin layer side.

In the present embodiment, the polarizer layer 101 is in direct contact with the resin layer 102. However, the polarizer layer and the resin layer may be laminated through another layer such as, for example, an adhesive layer.

### Second Embodiment

FIG. 2 is a cross-sectional view schematically illustrating an image display device including a polarizing film according to a second embodiment of the present invention. An image display device 250 includes an image display element 251 and a polarizing film 200. The polarizing film 200 includes a polarizer layer 201, a resin layer 202, an adhesive layer 203, and a hard coat layer 204 in this order, and the hard coat layer 204 is in direct contact with the adhesive layer 203. The resin layer 202 and the hard coat layer 204 are laminated through the adhesive layer 203. The polarizer layer 201 is in direct contact with the resin layer 202, and a surface 202U of the resin layer 202 and a surface 204D of the hard coat layer 204 are in direct contact with the adhesive layer 203. The polarizing film 200 further includes a tackiness layer 205. The tackiness layer 205 is disposed on the polarizer layer 201 on the side opposite to the resin layer 202 side. More specifically, the tackiness layer 205 is disposed so as to come in direct contact with a surface 201D of the polarizer layer 201 on the side opposite to a surface in contact with the resin layer 202. In the present embodiment, the polarizer layer 201 is in direct contact with the resin layer 202. However, the polarizer layer and the resin layer may be laminated through another layer such as, for example, an adhesive layer.

The polarizing film 200 is bonded to the image display element 251 such that the tackiness layer 205 is in contact with the image display element 251. In the present embodiment, the polarizing film 200 is bonded to the image display element 251. However, the polarizing film is not necessarily bonded to the image display element.

Any image display element may be used as the image display element 251. Examples of the image display element may include a liquid crystal display element (for example, a TN (twisted nematic) liquid crystal display element, an STN (super twisted nematic) liquid crystal display element, an HAN (hybrid alignment nematic) liquid crystal display element, an IPS (in-plane switching) liquid crystal display element, a VA (vertical alignment) liquid crystal display element, an MVA (multiple vertical alignment) liquid crystal display element, an OCB (optical compensated bend) liquid crystal display element) and an OLED display device.

### Third Embodiment

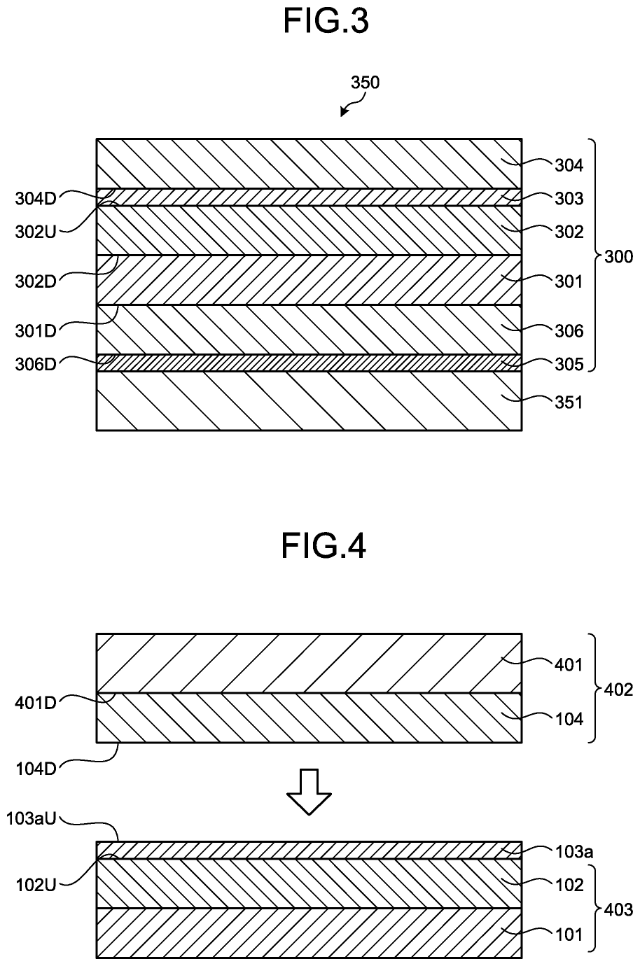

FIG. 3 is a cross-sectional view schematically illustrating an image display device including a polarizing film according to a third embodiment of the present invention. An image display device 350 includes an image display element 351 and a polarizing film 300. The polarizing film 300 includes a tackiness layer 305, an optically anisotropic layer 306, a polarizer layer 301, a resin layer 302, an adhesive layer 303, and a hard coat layer 304 in this order, and the hard coat layer 304 is in direct contact with the adhesive layer 303. The resin layer 302 and the hard coat layer 304 are laminated through the adhesive layer 303. A surface 302U of the resin layer 302 and a surface 304D of the hard coat layer are in direct contact with the adhesive layer 303.

The polarizer layer 301 is in direct contact with a surface 302D of the resin layer 302 on the side opposite to a surface 302U of the resin layer 302 in contact with the adhesive layer 303. In the present embodiment, the polarizer layer 301 is in direct contact with the resin layer 302 in this manner. However, the polarizer layer and the resin layer may be laminated through another layer such as, for example, an adhesive layer.

The optically anisotropic layer 306 is in direct contact with a surface 301D of the polarizer layer 301 on the side opposite to a surface in contact with the resin layer 302. In the present embodiment, the polarizer layer 301 is in direct contact with the optically anisotropic layer 306 in this manner. However, the polarizer layer and the optically anisotropic layer may be laminated through another layer such as, for example, an adhesive layer.

The tackiness layer 305 is disposed on a side of the polarizer layer 301 that is opposite to the resin layer 302 side. More specifically, the tackiness layer 305 is disposed so as to come in direct contact with a surface 306D of the optically anisotropic layer 306 on the side opposite to the surface 301D. In the present embodiment, the polarizing film 300 includes the tackiness layer 305. However, the polarizing film does not necessarily include the tackiness layer.

The polarizing film 300 is bonded to the image display element 351 such that the tackiness layer 305 is in contact with the image display element 351. In the present embodiment, the polarizing film 300 is bonded to the image display element 351. However, the polarizing film is not necessarily bonded to the image display element.

Any image display element may be used as the image display element 351. Examples of the image display element may include the liquid crystal display elements exemplified in the description of the image display element 251.

The polarizing film 300 includes the optically anisotropic layer 306. Thus, in a case where the optically anisotropic layer 306 is configured as a 1/4λ plate, in particular, the polarizing film 300 is used preferably with an OLED display element.

### 2. Producing Method of Polarizing Film

The polarizing film of the present invention may be produced by any method. An embodiment of the method for producing the polarizing film will be described below with reference to the drawings.

FIG. 4 is an explanatory diagram illustrating the method for producing the polarizing film according to an embodiment of the present invention.

The producing method of the present embodiment includes a step of forming the hard coat layer 104 on a surface 401D of a temporary support 401 to obtain a transfer laminated body 402, a step of preparing a laminated body 403 including the polarizer layer 101 and the resin layer 102, a step of bonding the surface 102U of the resin layer 102 side of the laminated body 403 and the hard coat layer 104 formed on the surface 401D of the temporary support 401 through an adhesive layer 103a, and a step of peeling off the temporary support 401 from the hard coat layer 104.

According to the producing method of the present embodiment, the hard coat layer 104 is previously formed on the temporary support 401, and then the hard coat layer 104 and the laminated body 403 are bonded through the adhesive layer 103a. Thus, occurrence of significant curling can be prevented in the polarizing film thus produced. On the other hand, in a case where the hard coat layer is formed by directly applying a composition for forming the hard coat layer onto the laminated body, followed by curing, the composition for forming the hard coat layer undergoes shrinkage during curing. As a result, the degree of curling in the polarizing film including the hard coat layer increases.

Any film may be used as the temporary support 401. A resin film including a polymer is usually used as the temporary support 401. Examples of the polymer that may be contained in the temporary support 401 may include a chain olefin polymer, a cycloolefin polymer, polycarbonate, polyester, polysulfone, polyether sulfone, polystyrene, polyvinyl alcohol, a cellulose acetate-based polymer, polyvinyl chloride, and polymethacrylate. Among the polymers that may be contained in the temporary support 401, a polymer having low adhesiveness to the hard coat layer 104 (for example, a cycloolefin polymer) is preferable from the viewpoint of facilitating the peeling of the temporary support 401.

Specific examples of a method for forming the hard coat layer 104 on the temporary support 401 may include a method in which the composition for forming the hard coat layer is applied onto the surface 401D of the temporary support 401 and the coating film is dried, and the coating film is then subjected to a curing treatment if necessary. Examples of a coating method may include a wire bar coating method, a dipping method, a spray method, a spin coating method, a roll coating method, a gravure coating method, and die coating. Examples of the conditions for drying the coating film may include a temperature of 70° C. to 120° C. and a drying time of 1 to 5 minutes. In a case where the composition for forming the hard coat layer includes an active energy ray curing resin, the coating film after being dried may be irradiated with an active energy ray such as an ultraviolet ray for curing, to thereby form the hard coat layer. The irradiation intensity and the irradiation time of the active energy ray may be appropriately set in accordance with a type of the active energy ray curing resin, or the like.

Examples and preferable examples of the composition for forming the hard coat layer are the same as those described in the aforementioned section [1.3. Hard coat layer].

The step of preparing the laminated body 403 may include, for example, a step of boding the polarizer layer 101 and the resin layer 102 through the adhesive layer. The step of preparing the laminated body 403 may include a step of stretching a laminated body including a non-stretched polarizer layer and a non-stretched resin layer.

Examples and preferable examples of the polarizer layer 101 and the resin layer 102 are the same as those described in the aforementioned sections [1.2. Polarizer layer] and [1.1. Resin layer].

The step of bonding the surface 102U on the resin layer 102 side of the laminated body 403 and the hard coat layer 104 through the adhesive layer 103a may include, for example, a step of performing a surface treatment such as a corona treatment on the surface of the surface 102U on the resin layer 102 side of the laminated body 403, may include a step of applying a material of the adhesive layer 103a onto the surface 102U on the resin layer 102 side of the laminated body 403 and/or the surface 104D of the hard coat layer 104 to thereby obtain a coating film, may include a step of removing the solvent from the obtained coating film, may include a step of allowing the surface 102U on the resin layer 102 side of the laminated body 403 and the surface 104D of the hard coat layer 104 to face each other through the obtained coating film, and may include a step of curing the coating film. Usually, as a result of performing the step of curing the coating film after the step of allowing the surface 102U of the resin layer 102 of the laminated body 403 and the hard coat layer 104 to face each other through the obtained coating film, the surface 102U of the resin layer 102 of the laminated body 403 and the hard coat layer 104 are bonded through the adhesive layer 103a.

In the present embodiment, the resin layer 102 is located on the outermost side of the laminated body 403 and the surface 102U of the resin layer 102 of the laminated body is located on the side where the resin layer 102 is exposed. Further, in the present embodiment, a surface 103aU of the adhesive layer 103a formed on the surface 102U on the resin layer 102 side of the laminated body 403 is in contact and bonded with the surface 104D of the hard coat layer.

Examples of a method for applying the material of the adhesive layer 103a onto the surface 102U on the resin layer 102 side of the laminated body 403 and/or the surface 104D of the hard coat layer 104 may include the same coating methods described in the aforementioned method for forming the hard coat layer.

Examples of the material of the adhesive layer 103a may include the same examples as those of the adhesive described in the aforementioned section [1.4. Adhesive layer].

### EXAMPLES

Hereinafter, the present invention will be specifically described by illustrating Examples. However, the present invention is not limited to the Examples described below. The present invention may be optionally modified for implementation without departing from the scope of claims of the present invention and its equivalents.

In the following description, “%” and “part” representing quantity are on the basis of weight, unless otherwise specified. The following operations were performed at normal temperature and under normal pressure, unless otherwise specified.

### Evaluation Methods

[Method for Measuring Weight-Average Molecular Weight and Number-Average Molecular Weight]

The weight-average molecular weight and the number-average molecular weight of the polymer were measured as a polystyrene-equivalent value or a polyisoprene-equivalent value using a gel permeation chromatography (GPC) system (“HLC8020GPC” manufactured by Tosoh Corp.). As a solvent, tetrahydrofuran was used in a case of using polystyrene as a standard substance and cyclohexane was used in a case of using polyisoprene as a standard substance. Further, the measuring temperature was 38° C.

[Method for Measuring Hydrogenation Rate of Polymer]

The hydrogenation rate of the polymer was measures by ¹H-NMR measurement.

[Method for Measuring Thickness]

The thickness of the film was measured by a snap gage.

[Method for Measuring Storage Elastic Modulus]

The storage elastic modulus was measured using a dynamic viscoelasticity measuring apparatus (“ARES” manufactured by TA Instruments Japan Inc.) under a condition of increasing the temperature from −100° C. to +250° C. at a rate of 5° C./min.

[Method for Measuring Water Vapor Transmission Rate]

The water vapor transmission rate was measured using a water vapor transmission rate measuring apparatus (“PERMATRAN-W” manufactured by MOCON Inc.) in accordance with JIS K 7129 B method under conditions of a temperature of 40° C. and a humidity of 90% RH.

[Method for Evaluating Curling Degree]

A 10-cm square cut piece was cut out from the film and the cut-out cut piece was allowed to stand for 24 hours under environments of 23° C. and 55% RH for moisture conditioning. Subsequently, the cut piece was placed on a surface plate with the hard coat layer facing upward. The height of each of four vertices of the cut piece from the horizontal plane of the surface plate was measured and the maximum value h1 of the height of the four vertices was obtained. The degree of curling of the film was evaluated from the maximum value h1 of the height according to the following criteria.

AA: h1≤10 mm—very small degree of curling with excellent mountability to panel

A: 10 mm<h1≤25 mm—small degree of curling with good mountability to panel

B: 25 mm<h1≤40 mm—large degree of curling with poor mountability to panel, causing reduction in yield of panels

C: 40 mm<h1—very large degree of curling, causing difficulty in mounting to panel

[Reliability of Polarizing Film]

A 10-cm square cut piece was cut out from the polarizing film on which the tackiness layer was formed, and the cut-out cut piece was bonded to a glass plate (“EAGLE XG” (registered trademark) manufactured by Corning Inc.) through the tackiness layer to obtain a sample for evaluating reliability. After the sample for evaluating reliability was allowed to stand for 120 hours in a thermostat at 85° C. and 85% RH, the sample for evaluating reliability was placed on an IPS liquid crystal monitor (LG23MP47HQ-P manufactured by LG Electronics) in which a part of the polarizing film on a view side was removed, and deterioration of the display image was compared and evaluated by visual inspection. Less deterioration of the display image indicates higher reliability of the polarizing film.

AA: no confirmed display image deterioration

A: extent of deterioration not posing problem in image display

B: extent of deterioration posing slight problem in image display

C: extent of deterioration posing significant problem in image display

[Bending Restorability of Film]

In accordance with JIS K 5600-5-1 (bend resistance (cylindrical mandrel method)), a sample was bent using a testing machine equipped with a mandrel having a diameter of 2 mm and kept in the bending state for 24 hours. After 24 hours, the sample was taken out from the testing machine, and distortion of reflected light in the bent part of the sample was visually observed to evaluate bending restorability of the film according to the following criteria.

A: completely restored without distortion

B: partially restored with some distortion

C: not restored with significant distortion

### Example 1

### 1-1. Production of Resin x1

A resin x1 was obtained by mixing 100 parts by weight of a norbornene-based polymer (norbornene-based resin (ZEONOR 1420: glass transition temperature Tg=137° C., weight-average molecular weight of 30000: manufactured by ZEON Corporation) and 50 parts by weight of polyisobutene (“Nisseki Polybutene HV-300” manufactured by JXTG Nippon Oil & Energy Corp., number-average molecular weight of 1,400) as a plasticizer.

### 1-2. Production of Resin Layer

The resin x1 was supplied to a thermal melt extrusion film molding machine equipped with a T-die, and the resin x1 was extruded from the T-die and wound up by a roll at a taking-up speed of 4 m/min to obtain a resin layer A1 (thickness of 12 μm) formed in a long-length film shape.

Further, a film having a thickness of 1 mm was produced from the resin x1 by the following method and the storage elastic modulus of the film was measured. The storage elastic modulus of the resin x1 measured as the film having a thickness of 1 mm was 900 MPa.

(Method for Creating Film Having Thickness of 1 mm)

The resin x1 (resin layer A1) was molded by thermal melting using a thermal melt pressing machine under conditions with a clearance of 1 mm, 250° C., and 30 MPa to obtain a film for measurement having a thickness of 1 mm.

Further, a film having a thickness of 100 μm was produced from the resin x1 by the following method and the water vapor transmission rate of the film at 40° C. and 90% RH was measured. The water vapor transmission rate of the resin x1 measured as the film having a thickness of 100 was 4.5 g/(m²·day).

(Method for Creating Film Having Thickness of 100 μm)

The film having a thickness of 100 μm was obtained using the same method as the method for creating the film having a thickness of 1 mm except that the clearance was changed to 100 μm.

### 1-3. Production of Polarizer

As a primary film, a non-stretched polyvinyl alcohol film (vinylon film, average polymerization degree of about 2400, saponification degree of 99.9 mol %) having a thickness of 60 μm was used. While the film was continuously conveyed in the lengthwise direction through a guide roll, the film was subjected to a swelling treatment and then a dyeing treatment, allowing the film to absorb iodine. In the swelling treatment, the film was immersed in pure water for 1 minute at 30° C. In the dyeing treatment, the film was immersed in a dyeing solution (dyeing agent solution containing iodine and potassium iodide in a molar ratio of 1:23, dyeing agent concentration of 1.2 mmol/L) for 2 minutes at 32° C. Subsequently, the film was washed with a 3% boric acid aqueous solution for 30 seconds at 35° C. and then the film was stretched to 2 times in an aqueous solution containing 3% boric acid and 5% potassium iodide at 57° C. Subsequently, the film was subjected to a complementary color treatment in an aqueous solution containing 5% potassium iodide and 1.0% boric acid at 35° C. and then dried for 2 minutes at 60° C. to obtain a polarizer P1 having a thickness of 23 The total stretching ratio of the polarizer thus obtained was 6.0 times, and the moisture content of the polarizer P1 measured by an inline moisture content measuring device manufactured by KURABO INDUSTRIES Ltd. was 7.5%.

### 1-4. Preparation of Hard Coat Layer Forming Composition H1

To 100 parts of a urethane acrylate oligomer including an acryloyl group having six or more functional groups (trade name “UV-1700B” manufactured by Nippon Synthetic Chemical Industry Co., Ltd.), 20 parts of silica particles (manufactured by CIK-Nano Tek., number-average particle diameter of 30 nm) and 6 parts of a photopolymerization initiator (trade name “IRGACURE184” manufactured by Ciba Specialty Chemicals Inc.) were added, and the mixture was stirred using a stirrer at 2000 rpm for 5 minutes to obtain a hard coat layer forming composition H1.

### 1-5. Formation of Hard Coat Layer

The hard coat layer forming composition H1 was applied onto a surface of a thermoplastic resin film (trade name “ZEONOR FILM ZF14” manufactured by ZEON Corporation) having a thickness of 23 μm as a temporary support using a gravure coater, and the applied composition was dried (90° C. for 2 minutes) and subjected to ultraviolet irradiation (integrated light quantity of 200 mW/cm²) to form a hard coat layer having a film thickness of 7 μm, thereby obtaining a transfer film.

### 1-6. Preparation of Laminated Body

An inline corona treatment was performed on one surface of the obtained resin layer A1, and then an ultraviolet (UV)-curable adhesive (“ARKLS KRX-7007” manufactured by ADEKA Corp.) was applied onto the corona treated surface by gravure coating to form an adhesive coating layer. The resin layer and the polarizer P1 were bonded through the adhesive coating layer by a pinch roll, and, immediately after that, UV irradiation was performed at 750 mJ/cm² using a UV irradiation device to obtain a laminated body having a layer configuration of “polarizer layer/adhesive layer (thickness of 2 μm)/resin layer”.

### 1-7. Bonding of Resin Layer and Hard Coat Layer

Subsequently, an inline corona treatment was performed on an outer exposed surface (the other surface) of the resin layer of the obtained laminated body, and then the UV-curable adhesive (“ARKLS KRX-7007” manufactured by ADEKA Corp.) was applied onto this resin layer surface by gravure coating to form an adhesive coating layer. The resin layer of the laminated body and the hard coat layer of the transfer film were bonded through the adhesive coating layer by a pinch roll, and, immediately after that, UV irradiation was performed at 500 mJ/cm² using a UV irradiation device to obtain a polarizing film Fla having a layer configuration of “temporary support/hard coat layer/adhesive layer/resin layer/adhesive layer/polarizer layer”.

### 1-8. Peeling of Temporary Support

From the polarizing film Fla (laminated body) having a layer configuration of “temporary support/hard coat layer/adhesive layer/resin layer/adhesive layer/polarizer layer”, the ZEONOR FILM ZF14 as the temporary support was removed to obtain a polarizing film F1b. The total thickness of the obtained polarizing film F1b was 47 The obtained polarizing film F1b was evaluated for the degree of curling and the bending restorability. The results are shown in Table 1.

### 1-9. Formation of Tackiness Layer

Preparation of tackiness agent composition P1 In a reaction vessel, 69 parts by weight of n-butyl acrylate (n-BA), 30 parts by weight of phenoxydiethylene glycol acrylate, 1 part by weight of 4-hydroxybutyl acrylate (4HBA), 120 parts by weight of ethyl acetate, and 0.1 part by weight of azobisisobutyronitrile (AIBN) were placed. The air inside the reaction vessel was replaced with nitrogen gas and then, while stirring under the nitrogen atmosphere, the reaction solution was heated to 66° C. to perform a reaction for 10 hours. After completion of the reaction, the reaction solution was diluted with ethyl acetate to obtain an acryl-based copolymer solution (tackiness agent composition P1) having a solid content of 20% by weight. The weight-average molecular weight (Mw) of the obtained acryl-based copolymer by GPC was 1,100,000.

To 500 parts by weight (solid content of 100 parts by weight) of the tackiness agent composition P1, 0.1 part by weight of an isocyanate-based crosslinking agent (“Coronate L” manufactured by Nippon Polyurethane Industry Co., Ltd.) and 0.1 part by weight of a silane coupling agent (“KBM-402” manufactured by Shin-Etsu Polymer Co., Ltd.) were added, and the mixture was sufficiently mixed to obtain a tackiness agent composition. The obtained tackiness agent composition was applied onto a PET film (“MRV38” manufactured by Mitsubishi Chemical Corp.), to which a release treatment with silicone had been applied, using a die coater and then dried at 90° C. for 3 minutes to vaporize the solvent content, thereby forming a tackiness layer of 20 μm. Subsequently, the PET film on which the tackiness layer was formed was bonded to a surface on the side opposite to the resin layer side of the polarizer layer of the polarizing film F1b to form the tackiness layer, thereby obtaining a polarizing film F1c having a layer configuration of “hard coat layer/adhesive layer/resin layer/adhesive layer/polarizer layer/tackiness layer/PET film”. After the obtained polarizing film F1c was aged by storing the film for 5 days under conditions of a temperature of 23° C. and a humidity of 55%, the PET film was removed and the resulting film was attached to glass to evaluate reliability at 85° C. and 85% RH. The results are shown in Table 1.

### Example 2

The resin x1 produced by the same manner as that in [1-1. Production of resin x1] in Example 1 was supplied to a thermal melt extrusion film molding machine equipped with a T-die. The resin x was extruded from the T-die and wound up by a roll at a taking-up speed of 4.1 m/min to obtain a non-stretched resin layer (thickness of 10 μm) formed in a long-length film shape.

The non-stretched resin layer thus obtained was subjected to free-end uniaxial stretching to 3 times at 140° C. to obtain a resin layer A2 having a thickness of 6

A polarizing film F2a including the temporary support was obtained by the same manner as that in [1-6. Preparation of laminated body] and [1-7. Bonding of resin layer and hard coat layer] in Example 1 except that the resin layer A2 was used instead of the resin layer A1. A polarizing film F2b was obtained by the same manner as that in [1-8. Peeling of temporary support] in Example 1 except that the polarizing film F2a was used instead of the polarizing film Fla. A polarizing film F2c including the tackiness layer was obtained by the same manner as that in [1-9. Formation of tackiness layer] in Example 1 except that the polarizing film F2b was used instead of the polarizing film F1b.

The total thickness of the polarizing film F2b was 40 μm. The total thickness of the polarizing film F2c is shown in Table 1. Further, the evaluation results of the polarizing film are shown in Table 1.

### Example 3

### [3-1. Production of Polymer Y] Production of Hydrogenated Product [E] of Block Copolymer

With reference to a production example described in Japanese Patent Application Laid-Open No. 2002-105151 A, a block copolymer [D1] was obtained by sequentially polymerizing 25 parts of a styrene monomer in a first step, 30 parts of a styrene monomer and 25 parts of an isoprene monomer in a second step, and 20 parts of a styrene monomer in a third step. After that, the block copolymer was hydrogenated to synthesize a hydrogenated product [E1] of the block copolymer. The hydrogenated product [E1] of the block copolymer had an Mw of 84,500, an Mw/Mw ratio of 1.20, and a hydrogenation rate in main chains and aromatic rings of about 100%.

To 100 parts of the hydrogenated product [E1] of the block copolymer, 0.1 part of pentaerythrityl tetrakis[3-(3,5-di-t-butyl-4-hydroxyphenyl)propionate] (manufactured by Songwon, trade name “SONGNOX1010”) as an antioxidant was mixed by melt kneading, and then the mixture was pelletized to obtain a resin y1 for molding.

Further, a film having a thickness of 1 mm was produced from the resin y1 and the storage elastic modulus of the film was measured. The storage elastic modulus of the resin y1 measured as the film having a thickness of 1 mm was 810 MPa. The method for producing the film having a thickness of 1 mm from the resin y1 was the same as the aforementioned method for producing the film having a thickness of 1 mm from the resin x1.

A film having a thickness of 100 μm was produced from the resin y1 and the water vapor transmission rate of the film at 40° C. and 90% RH was measured. The water vapor transmission rate of the resin y1 measured as the film having a thickness of 100 μm was 4.0 g/(m²·day). The method for producing the film having a thickness of 100 μm from the resin y1 was the same as the aforementioned method for producing the film having a thickness of 100 μm from the resin x1.

### 3-2. Production of Resin Layer

The resin y1 was supplied to a thermal melt extrusion film molding machine equipped with a T-die. The resin y1 was extruded from the T-die and wound up by a roll at a taking-up speed of 4.1 m/min to mold the resin y1 in a film shape. In this manner, a long-length non-stretched resin layer (thickness of 10 μm) formed of the resin y1 was obtained.

The non-stretched resin layer formed of the resin y1 thus obtained was subjected to free-end uniaxial stretching to 6 times at 140° C. to obtain a resin layer B1 having a thickness of 4

### 3-3. Production of Polarizing Film

A polarizing film F3a including a temporary support was obtained by the same manner as that in [1-6. Preparation of laminated body] and [1-7. Bonding of resin layer and hard coat layer] in Example 1 except that the resin layer B1 was used instead of the resin layer A1. A polarizing film F3b was obtained by the same manner as that in [1-8. Peeling of temporary support] in Example 1 except that the polarizing film F3a was used instead of the polarizing film Fla. A polarizing film F3c including a tackiness layer was obtained by the same manner as that in [1-9. Formation of tackiness layer] in Example 1 except that the polarizing film F3b was used instead of the polarizing film F1b.

The total thickness of the polarizing film F3b was 38 mm. The total thickness of the polarizing film F3c is shown in Table 1. Further, the evaluation results of the polarizing film are shown in Table 1.

### Example 4

### 4-1. Production of Polarizer

A polarizer P2 having a thickness of 7 μm was produced by the same manner as that in [1-3. Production of polarizer] in Example 1 except that a non-stretched polyvinyl alcohol film (average polymerization degree of about 2400, saponification degree of 99.9 mol %) having a thickness of 20 μm was used as a primary film instead of the non-stretched polyvinyl alcohol film having a thickness of 60 μm.

### 4-2. Production of Polarizing Film

A polarizing film F4a including a temporary support was obtained by the same manner as that in [1-6. Preparation of laminated body] and [1-7. Bonding of resin layer and hard coat layer] in Example 1 except that the resin layer B1 obtained by the same manner as that in [3-2. Production of resin layer] in Example 3 was used instead of the resin layer A1 and the polarizer P2 was used instead of the polarizer P1. A polarizing film F4b was obtained by the same manner as that in [1-8. Peeling of temporary support] in Example 1 except that the polarizing film F4a was used instead of the polarizing film Fla. A polarizing film F4c including a tackiness layer was obtained by the same manner as that in [1-9. Formation of tackiness layer] in Example 1 except that the polarizing film F4b was used instead of the polarizing film F1b.

The total thickness of the polarizing film F4b was 22 μm. The total thickness of the polarizing film F4c is shown in Table 1. Further, the evaluation results of the polarizing film are shown in Table 1.

### Example 5

### 5-1. Production of Resin Layer B2

A resin layer B2 (thickness of 10 μm) was obtained by the same manner as that in [3-2. Production of resin layer] in Example 3 except that a resin y2, which is a mixture of 100 parts by weight of the resin y1 produced by the same manner as that in [3-1. Production of polymer] in Example 3 and 30 parts by weight of polyisobutene (“Nisseki Polybutene HV-300” manufactured by JXTG Nippon Oil & Energy Corp., number-average molecular weight of 1,400) as a plasticizer, was used instead of the resin y1.

Further, a film having a thickness of 1 mm was produced from the resin y2 and the storage elastic modulus of the film was measured. The storage elastic modulus of the resin y2 measured as the film having a thickness of 1 mm was 720 MPa. The method for producing the film having a thickness of 1 mm from the resin y2 was the same as the aforementioned method for producing the film having a thickness of 1 mm from the resin x1.

A film having a thickness of 100 μm was produced from the resin y2 and the water vapor transmission rate of the film at 40° C. and 90% RH was measured. The water vapor transmission rate of the resin y2 measured as the film having a thickness of 100 μm was 4.8 g/(m²·day). The method for producing the film having a thickness of 100 from the resin y2 was the same as the aforementioned method for producing the film having a thickness of 100 μm from the resin x1.

### 5-2. Production of Polarizing Film

A polarizing film F5a including a temporary support was obtained by the same manner as that in [1-6. Preparation of laminated body] and [1-7. Bonding of resin layer and hard coat layer] in Example 1 except that the resin layer B2 was used instead of the resin layer A1 and the polarizer P2 obtained by the same manner as that in [4-1. Production of polarizer] in Example 4 was used instead of the polarizer P1. A polarizing film F5b was obtained by the same manner as that in [1-8. Peeling of temporary support] in Example 1 except that the polarizing film F5a was used instead of the polarizing film Fla. A polarizing film F5c including a tackiness layer was obtained by the same manner as that in [1-9. Formation of tackiness layer] in Example 1 except that the polarizing film F5b was used instead of the polarizing film F1b.

The total thickness of the polarizing film F5b was 22 μm. The total thickness of the polarizing film F5c is shown in Table 1. Further, the evaluation results of the polarizing film are shown in Table 1.

### Example 6

### 6-1. Production of Polarizer

A polarizer P3 having a thickness of 5 μm was produced by the same manner as that in [1-3. Production of polarizer] in Example 1 except that a non-stretched polyvinyl alcohol film (average polymerization degree of about 2400, saponification degree of 99.9 mol %) having a thickness of 15 μm was used as a primary film instead of the non-stretched polyvinyl alcohol film having a thickness of 60 μm.

### 6-2. Production of Polarizing Film

A polarizing film F6a including a temporary support was obtained by the same manner as that in [1-6. Preparation of laminated body] and [1-7. Bonding of resin layer and hard coat layer] in Example 1 except that the resin B1 obtained by the same manner as that in [3-2. Production of resin layer] in Example 3 was used instead of the resin layer A1 and the polarizer P3 was used instead of the polarizer P1. A polarizing film F6b was obtained by the same manner as that in [1-8. Peeling of temporary support] in Example 1 except that the polarizing film F6a was used instead of the polarizing film Fla. A polarizing film F6c including a tackiness layer was obtained by the same manner as that in [1-9. Formation of tackiness layer] in Example 1 except that the polarizing film F6b was used instead of the polarizing film F1b.

The total thickness of the polarizing film F6b was 20 μm. The total thickness of the polarizing film F6c is shown in Table 1. Further, the evaluation results of the polarizing film are shown in Table 1.

### Example 7

### 7-1. Production of Resin Layer B3

The resin y1 obtained by the same manner as that in [3-1. Production of polymer Y] in Example 3 was supplied to a thermal melt extrusion film molding machine equipped with a T-die. The resin y1 was extruded from the T-die and wound up by a roll at a taking-up speed of 4.3 m/min to mold the resin y1 in a film shape. In this manner, a long-length non-stretched resin layer (thickness of 6 μm) formed of the resin y1 was obtained.

The non-stretched resin layer formed of the resin y1 thus obtained was subjected to free-end uniaxial stretching to 6 times at 140° C. to obtain a resin layer B3 having a thickness of 2 μm.

### 7-2. Production of Polarizing Film

A polarizing film F7a including a temporary support was obtained by the same manner as that in [1-6. Preparation of laminated body] and [1-7. Bonding of resin layer and hard coat layer] in Example 1 except that the resin B3 was used instead of the resin layer A1 and the polarizer P3 obtained by the same manner as that in [6-1. Production of polarizer] in Example 6 was used instead of the polarizer P1. A polarizing film F7b was obtained by the same manner as that in [1-8. Peeling of temporary support] in Example 1 except that the polarizing film F7a was used instead of the polarizing film Fla. A polarizing film F7c including a tackiness layer was obtained by the same manner as that in [1-9. Formation of tackiness layer] in Example 1 except that the polarizing film F7b was used instead of the polarizing film F1b.

The total thickness of the polarizing film F7b was 18 μm. The total thickness of the polarizing film F7c is shown in Table 1. Further, the evaluation results of the polarizing film are shown in Table 1.

### Comparative Example 1

### C1-1. Production of Resin Layer C

An acrylic resin (“SUMIPEX HT55X” manufactured by Sumitomo Chemical Co., Ltd.) was supplied to a thermal melt extrusion film molding machine equipped with a T-die. The acrylic resin was extruded from the T-die and wound up by a roll at a taking-up speed of 4 m/min to mold the acrylic resin in a film shape. In this manner, a long-length resin layer C (thickness of 40 μm) formed of the acrylic resin was obtained.

Further, a film having a thickness of 1 mm was produced from the acrylic resin (“SUMIPEX HT55X” manufactured by Sumitomo Chemical Co., Ltd.) and the storage elastic modulus of the film was measured. The storage elastic modulus of the acrylic resin measured as the film having a thickness of 1 mm was 2800 MPa. The method for producing the film having a thickness of 1 mm from the acrylic resin was the same as the aforementioned method for producing the film having a thickness of 1 mm from the resin x1.

### C1-2. Formation of Hard Coat Layer

The hard coat layer forming composition H1 obtained by the same manner as that in [1-4. Preparation of hard coat layer forming composition H1] in Example 1 was applied onto a surface of the resin layer C using a gravure coater, and the applied composition was dried (90° C. for 2 minutes) and subjected to ultraviolet irradiation (integrated light quantity of 200 mW/cm²) to form a hard coat layer having a film thickness of 7 μm, thereby obtaining a laminated body including the hard coat layer.

### C1-3. Production of Polarizing Film

An inline corona treatment was performed on a surface of the resin layer C of the obtained laminated body including the hard coat layer, and then an ultraviolet (UV)-curable adhesive (“ARKLS KRX-7007” manufactured by ADEKA Corp.) was applied onto the corona treated surface by gravure coating to form an adhesive coating layer. The resin layer C and the polarizer P3 obtained by the same manner as that in [6-1. Production of polarizer] in Example 6 were bonded through the adhesive coating layer by a pinch roll, and, immediately after that, UV irradiation was performed at 750 mJ/cm² using a UV irradiation device to obtain a polarizing film FC1b having a layer configuration of “polarizer layer/adhesive layer/resin layer/hard coat layer”. A polarizing film FC1c including a tackiness layer was obtained by the same manner as that in [1-9. Formation of tackiness layer] in Example 1 except that the polarizing film FC1b was used instead of the polarizing film F1b.

The total thickness of the polarizing film FC1c is shown in Table 2. Further, the evaluation results of the polarizing film are shown in Table 2.

### Comparative Example 2

As a resin layer, a triacetyl cellulose (TAC) film (“FUJITAC T25” manufactured by FUJIFILM Corp., thickness of 25 μm) was prepared.

The storage elastic modulus of the triacetyl cellulose measured as a film having a thickness of 1 mm was 3400 MPa. The method for producing the film having a thickness of 1 mm from the triacetyl cellulose film was the same as the aforementioned method for producing the film having a thickness of 1 mm from the resin x1.

A polarizing film FC2b having a layer configuration of polarizer layer/adhesive layer/resin layer/hard coat layer, and a polarizing film FC2c including a tackiness layer were obtained by the same manner as that in [C1-2. Formation of hard coat layer] and [C1-3. Production of polarizing film] in Comparative Example except that the TAC film was used instead of the resin layer C and the polarizer P1 obtained by the same manner as that in [1-3. Production of polarizer] in Example 1 was used instead of the polarizer P3.

The total thickness of the polarizing film FC2c is shown in Table 2. Further, the evaluation results of the polarizing film are shown in Table 2.

### Comparative Example 3

The hard coat layer forming composition H1 obtained by the same manner as that in [1-4. Preparation of hard coat layer forming composition H1] in Example 1 was applied onto a surface of the polarizer P1 obtained by the same manner as that in [1-3. Production of polarizer] in Example 1 using a gravure coater, and the applied composition was dried (90° C. for 2 minutes) and subjected to ultraviolet irradiation (integrated light quantity of 200 mW/cm²) to form a hard coat layer having a film thickness of 7 μm, thereby obtaining a polarizing film FC3b including the hard coat layer. A polarizing film FC3c including a tackiness layer was obtained by the same manner as that in [1-9. Formation of tackiness layer] in Example 1 except that the polarizing film FC3b was used instead of the polarizing film F1b.

The total thickness of the polarizing film FC3c is shown in Table 2. Further, the evaluation results of the polarizing film are shown in Table 2.

TABLE 1

| | Ex. 1 | Ex. 2 | Ex. 3 | Ex. 4 | Ex. 5 | Ex. 6 | Ex. 7 |
|---|---|---|---|---|---|---|---|
| Resin layer | A1 | A2 | B1 | B1 | B2 | B1 | B3 |
| Resin layer material | x1 | x1 | y1 | y1 | y2 | y1 | y1 |
| Storage elastic modulus | 900 | 900 | 810 | 810 | 720 | 810 | 810 |
| [MPa] | | | | | | | |
| Resin layer thickness | 12 | 6 | 4 | 4 | 4 | 4 | 2 |
| [μm] | | | | | | | |
| Polarizer layer | P1 | P1 | P1 | P2 | P2 | P3 | P3 |
| Polarizer layer thickness | 23 | 23 | 23 | 7 | 7 | 5 | 5 |
| [μm] | | | | | | | |
| Total thickness of the | 66 | 60 | 58 | 42 | 42 | 40 | 38 |
| polarizing film including | | | | | | | |
| the tackiness layer [μm] | | | | | | | |
| Curling h1 [mm] | 22 | 18 | 16 | 10 | 8 | 6 | 4 |
| Evaluation | A | A | A | AA | AA | AA | AA |
| 85° C. 85% RH | AA | A | A | A | A | A | A |
| reliability evaluation | | | | | | | |
| Bending restorability | A | A | A | A | A | A | A |

TABLE 2

| | Comp. Ex. 1 | Comp. Ex. 2 | Comp. Ex. 3 |
|---|---|---|---|
| Resin layer | C | TAC film | none |
| Resin layer | PMMA | TAC | — |
| material | | | |
| Storage | 2800 | 3400 | — |
| elastic | | | |
| modulus [MPa] | | | |
| Resin layer | 40 | 25 | — |
| thickness [μm] | | | |
| Polarizer | P3 | P1 | P1 |
| layer | | | |
| Polarizer | 5 | 23 | 23 |
| layer | | | |
| thickness [μm] | | | |
| Total | 76 | 75 | 50 |
| thickness of | | | |
| the polarizing | | | |
| film including | | | |
| the tackiness | | | |
| layer [μm] | | | |
| Curling h1 [mm] | 36 | Unmeasurable* | Unmeasurable* |
| Evaluation | B | C | C |
| 85° C. 85% RH | B | C | Unevaluatable** |
| reliability | | | |
| evaluation | | | |
| Bending | C | B | Unevaluatable** |
| restorability | | | |

In Table 2, a symbol “*” indicates that the h1 was immeasurable due to significant degree of curling. In Table 2, a symbol “**” indicates that the film quality was too significantly poor to be evaluated.

In Table 2, PMMA represents an acrylic resin (“SUMIPEX HT55X” manufactured by Sumitomo Chemical Co., Ltd.).

From the aforementioned results, it is shown that the polarizing films in Examples each including the polarizer layer, the resin layer formed of the resin having a storage elastic modulus of 10 MPa or more and 1000 MPa or less, the adhesive layer, and the hard coat layer in this order can prevent the occurrence of the significant curling, exhibit the high reliability, and sufficiently protect the polarizer. Further, it is shown that these polarizing films are excellent in the bending restorability.

On the other hand, the polarizing films in Comparative Examples 1 and 2 each including the resin layer formed of the resin having a storage elastic modulus of more than 1000 MPa without having the adhesive layer between the resin layer and the hard coat layer, and the polarizing film in Comparative Example 3 not including the resin layer are inferior to the polarizing films in Examples in all evaluation results on the degree of curling, the reliability evaluation, and the bending restorability.

These results indicate that the present invention can provide the polarizing film capable of preventing occurrence of significant curling, sufficiently protecting the polarizer, and exhibiting high restorability after bending.

### REFERENCE SIGN LIST

100, 200, 300 polarizing film
101, 201, 301 polarizer layer
102, 202, 302 resin layer
103, 203, 303 adhesive layer
104, 204, 304 hard coat layer
250, 350 image display device
251, 351 image display element
306 optically anisotropic layer

1. A polarizing film comprising a polarizer layer, a resin layer, an adhesive layer, and a hard coat layer in this order, wherein
the resin layer is formed of a resin having a storage elastic modulus, measured as a film having a thickness of 1 mm, of 10 MPa or more and 1000 MPa or less, and
the adhesive layer is in direct contact with the hard coat layer.

2. The polarizing film according to claim 1, wherein a thickness of the resin layer is 1 μm or more and 13 μm or less.

3. The polarizing film according to claim 1, wherein a thickness of the polarizer layer is 1 μm or more and 25 μm or less.

4. The polarizing film according to claim 1, wherein a thickness of the adhesive layer is more than 0 μm and 5 μm or less.

5. The polarizing film according to claim 1, further comprising a tackiness layer provided on the polarizer layer on a side opposite to the resin layer side, wherein a thickness of the tackiness layer is 2 μm or more and 25 μm or less.

6. The polarizing film according to claim 1, wherein the resin has a water vapor transmission rate of less than 5 g/(m²·day) as measured as a film having a thickness of 100 μm at 40° C. and 90% RH.

7. The polarizing film according to claim 1, wherein the resin contains a polymer having an alicyclic structure.

8. The polarizing film according to claim 7, wherein the polymer having an alicyclic structure is one or more types selected from the group consisting of a hydrogenated product of a ring-opening polymer of a monomer having a norbornene structure, an addition copolymer of a monomer having a norbornene structure and an α-olefin, and a hydrogenated product of an addition copolymer of a monomer having a norbornene structure and an α-olefin.

9. The polarizing film according to claim 7, wherein
the polymer having an alicyclic structure is a hydrogenated product [E] of a block copolymer;
the hydrogenated product [E] of the block copolymer is a hydrogenated product of a block copolymer [D];
the block copolymer [D] is a block copolymer composed of a polymer block [A] and a polymer block [B] or a polymer block [C];
the polymer block [A] is a polymer block having as a main component a repeating unit [I] derived from an aromatic vinyl compound;
the polymer block [B] is a polymer block having as main components the repeating unit [I] derived from an aromatic vinyl compound and a repeating unit [II] derived from a chain conjugated diene compound; and
the polymer block [C] is a polymer block having as a main component the repeating unit [II] derived from a chain conjugated diene compound.

10. The polarizing film according to claim 1, wherein the resin further contains a plasticizer and/or a softener.

11. The polarizing film according to claim 10, wherein the plasticizer and/or softener is one or more types selected from the group consisting of a compound having an ester structure and an aliphatic hydrocarbon polymer.

12. The polarizing film according to claim 1, wherein, when a 10 cm square cut piece cut out from the polarizing film is placed on a horizontal plane after humidity control is performed in an environment of 23° C. and 55% RH for 24 hours, a maximum value of heights at four vertices of the cut piece from the horizontal plane is 30 mm or less.

13. The polarizing film according to claim 1, wherein the polarizer layer includes a polyvinyl alcohol resin.

14. A method for producing a polarizing film including a polarizer layer, a resin layer, an adhesive layer, and a hard coat layer in this order, the resin layer being formed of a resin having a storage elastic modulus, measured as a film having a thickness of 1 mm, of 10 MPa or more and 1000 MPa or less, the adhesive layer being in direct contact with the hard coat layer, the method comprising the steps of:
forming the hard coat layer on a surface of a temporary support;
preparing a laminated body including the polarizer layer and the resin layer;
bonding a surface of the resin layer of the laminated body and the hard coat layer formed on the surface of the temporary support through an adhesive layer; and
peeling off the temporary support from the hard coat layer.
